(19) United States
(12) Patent Application Publication
(10) Pub. No.: US 2007/0136782 A1
(43) Pub. Date: Jun. 14, 2007

(54) METHODS AND APPARATUS FOR IDENTIFYING MEDIA CONTENT

(76) Inventors: Arun Ramaswamy, Tampa, FL (US); David Howell Wright, Safety Harbor, FL (US); Alan Bosworth, Odessa, FL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/559,787

(22) Filed: Nov. 14, 2006

Related U.S. Application Data
(63) Continuation of application No. PCT/US05/17175, filed on May 16, 2005.
(60) Provisional application No. 60/571,378, filed on May 14, 2004.

(51) Int. Cl. H04N 7/173; H04N 7/16; H04N 7/12; H04N 11/04; H04N 5/38; H04N 5/222; H04N 11/02; H04B 1/66

(52) U.S. Cl. 725/138; 725/20; 375/240.25; 725/131; 725/139; 725/114; 348/723; 348/722

(57) ABSTRACT

Methods and apparatus for preparing media content for identification are disclosed. An example method includes receiving compressed media content, decompressing the payload of the compressed media content, generating a signature of the decompressed payload, discarding the decompressed payload, embedding a code in the compressed media content, and storing the code and the signature in a database for later use in identifying presentation of the media content at a presentation site.

### RELATED APPLICATIONS

This patent arises from a continuation of PCT Patent Application Serial No. PCT/US2005/017175, filed May 16, 2005, which claims priority from U.S. Provisional Patent Application Ser. No. 60/571,378, entitled “Methods and Apparatus for Encoding Media Content Prior to Broadcast” and filed May 14, 2004. Both the PCT Patent Application Serial No. PCT/US2005/017175 and the U.S. Provisional Patent Application Serial No. 60/571,378 are hereby incorporated herein by reference in their entirety.

### TECHNICAL FIELD

The present disclosure pertains to identifying media content and, more particularly, to methods and apparatus for encoding media content prior to broadcast.

### BACKGROUND

Determining audience size and demographics of programs and program sources (e.g., a television broadcast, a radio broadcast, an internet webcast, a pay-per-view program, live content, etc.) enables media program producers to improve the quality of media content and determine prices to be charged for advertising broadcast during such programming. In addition, accurate audience demographics enable advertisers to target audiences of a desired size and/or audiences including members having a set of desired characteristics (e.g., certain income levels, lifestyles, interests, etc.)

To collect viewing statistics and demographics, an audience measurement company may enlist a number of media consumers (e.g., viewers/listeners) to cooperate in an audience measurement study for a predefined amount of time. The viewing habits of the enlisted consumers, as well as demographic data about the enlisted consumers or respondents, may be collected using automated and/or manual collection methods. The collected consumption information (e.g., viewing and/or listening data) is then typically used to generate a variety of information, including, for example, audience sizes, audience demographics, audience preferences, the total number of hours of television viewing per household and/or per region, etc.

The configurations of automated data collection systems typically vary depending on the equipment used to receive, process, and display media signals in each monitored consumption site (e.g., a household). For example, consumption sites that receive cable television signals and/or satellite television signals typically include set top boxes (STBs) that receive broadcast signals from a cable and/or satellite provider. Media delivery systems configured in this manner may be monitored using hardware, firmware, and/or software that interfaces with the STB to extract or generate signal information therefrom. Such hardware, firmware, and/or software may be adapted to perform a variety of monitoring tasks including, for example, detecting the channel tuning status of a tuning device disposed in the STB, extracting identification codes (e.g., ancillary codes and/or watermark data) embedded in media signals received at the STB, verifying broadcast of commercial advertisements, collecting signatures characteristic of media signals received at the STB, etc.

Typically, identification codes (e.g., ancillary codes) are embedded in media signals at the time the media content is broadcast (i.e., at the broadcast station) in real-time. As a result, the number of and/or types of identification codes that may be embedded in the media signals are limited because the amount of time needed to embed and/or generate the identification codes may conflict with the real-time constraints of the broadcast system. For example, the time needed to generate and embed a large number of identification codes may exceed the time available during broadcasting of the media signals. In particular, in some systems, video frame data must be broadcast at a rate that ensures frames can be rendered at a sufficiently high rate (e.g., thirty frames per second) so that audience members perceive the video as displayed in real-time. In addition, the types of media formats (e.g., an analog media format, a compressed digital format, etc.) that may be used is limited because the broadcast system may not be configured to receive and/or encode media signals using multiple formats. For example, an analog cable system may not be configured to broadcast a program in a compressed digital format.

When media content is presented at a monitored consumption site identifying information about the presented media content is collected. The identifying data typically includes the embedded identification codes and timestamp information. The identifying data is then sent to a central location for processing. At the central location, the embedded identification codes and timestamps may be compared with program line-up data provided by broadcasters. However, using program line-up data is not suitable for all types of media broadcasts. For example, video on demand (VOD) broadcasting allows a consumer to select a program from a list of available programs and to cause the selected program to be broadcast immediately. VOD broadcasts, therefore, do not follow a set or predetermined program line-up and the broadcast pattern for each consumer may differ.

### BRIEF DESCRIPTION OF THE DRAWINGS

FIG. 1 is a block diagram of a known system that may be used to broadcast encoded media content.

FIG. 2 is a block diagram of a media monitoring system that may be used to identify encoded media content.

FIG. 3 is a block diagram of an example transmitter system that may be used to broadcast encoded media content.

FIG. 4 is a block diagram of an example system for implementing a content watermarking and signature system such as that shown in FIG. 3.

FIG. 5 is a block diagram of an example monitoring system that may be used to receive and identify media content.

FIG. 6 is a flowchart representative of an example manner in which an audio and video output process may be performed using all or part of the system of FIG. 3.

FIG. 7 is a flowchart representative of an example manner in which an audio encoding process such as that described in connection with FIG. 6 may be performed.

FIG. 8 is a flowchart representative of an example manner in which an audio and video output process such as that described in connection with FIG. 6 may be performed.

FIG. 9 is a flowchart representative of an example manner in which compressed digital media content may be encoded.

FIG. 10 is a block diagram of an example processor system that may be used to implement the example apparatus and methods disclosed herein.

### DETAILED DESCRIPTION

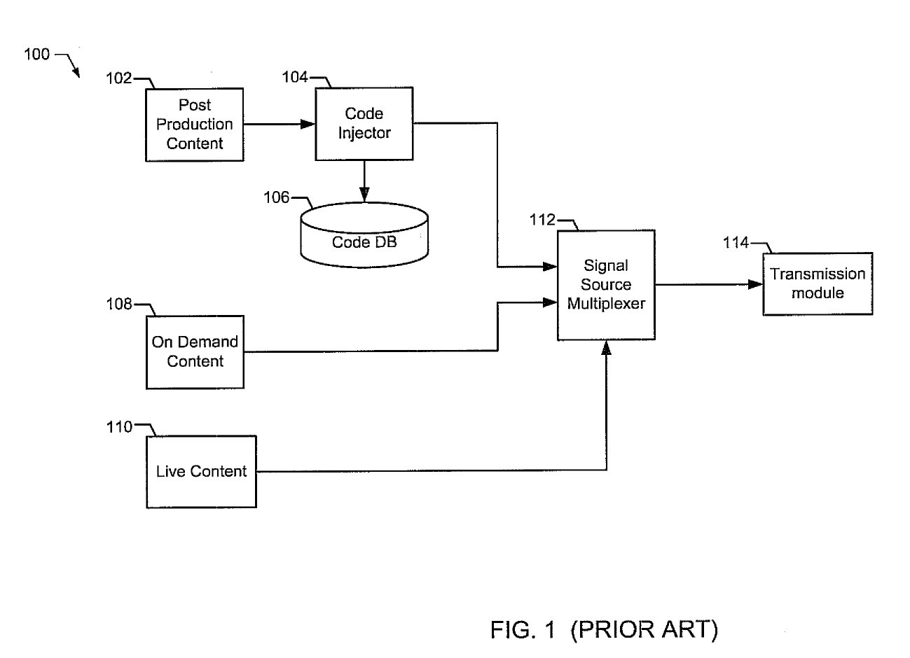

FIG. 1 is a block diagram of a known system 100 that may be used to broadcast encoded media content. The example system 100 may be implemented as several components of hardware, each of which may be configured to perform one or more functions, may be implemented in software or firmware, where one or more programs or collections of machine readable and executable instructions are used to perform the different functions, or may be implemented using a combination of hardware, firmware, and/or software. In this example, the example system 100 includes post production content 102, a code injector 104, a code database 106, on demand content 108, live content 110, a signal source multiplexer 112, and a transmission module 114.

The post production content 102 may be any form of pre-recorded media content such as recorded programs intended to be broadcast by, for example, a television network. The post production content 102 may be a television situational comedy, a television drama, a cartoon, a web page, a commercial, an audio program, a movie, etc. As the post production content 102 is broadcast and/or transmitted by the transmission module 114, the code injector 104 encodes the post production content 102 with identifying data and/or characteristics. For example, the code injector 104 may use any known encoding method such as inserting identifying data (e.g., audio and/or video watermark data, ancillary codes, metadata, etc.) into the video and/or audio signals of the post production content 102. The code injector 104 updates the code database 106 with information describing the post production content 102 and the identifying data used to identify the post production content 102. More specifically, the information contained in the code database 106 may be used by a receiving site (e.g., a consumption site, a monitored site, a reference site, etc.) to identify consumed media content by matching extracted identifying data to corresponding identifying data stored in the code database 106.

The on demand content 108 may include movies and/or other audio and/or video programs that are available for purchase by an audience member. The on demand content 108 may be stored on a server in a compressed digital format and/or a decompressed digital format. The audience member (e.g., a television viewer) may make a request to view the on demand content 108 from, for example, a cable company and/or a television service provider. Similar to the on demand content 108, the live content 110 may also be available for purchase. The live content 110 may include pay-per-view sporting events, concerts, etc.

The encoded post production content 102, the on demand content 108 and the live content 110 are received by the signal source multiplexer 112, which is configured to select between the available programming and/or create a signal that includes one or more types of content. For example, the signal source multiplexer 112 may create a signal so that the available programming is located on separate channels. For example, the post production content 102 may be on channels 2-13 and the on demand content 108 may be on channels 100-110. Alternatively, the signal source multiplexer 112 may splice or multiplex the available content into one signal. For example, the post production content 102 may be spliced so that it precedes and/or follows the on demand content 108. A person of ordinary skill in the art will readily appreciate that the signal source multiplexer 112 is well known in the art and, thus, is not described in further detail herein.

The transmission module 114 receives the media content (e.g., video and/or audio content) from the signal source multiplexer 112 and is configured to transmit the output of the signal source multiplexer 112 using any known broadcast technique such as a digital and/or analog television broadcast, a satellite broadcast, a cable transmission, etc. A person of ordinary skill in the art will readily appreciate that the transmission module 114 may be implemented using apparatus and methods that are well known in the art and, thus, are not described in further detail herein.

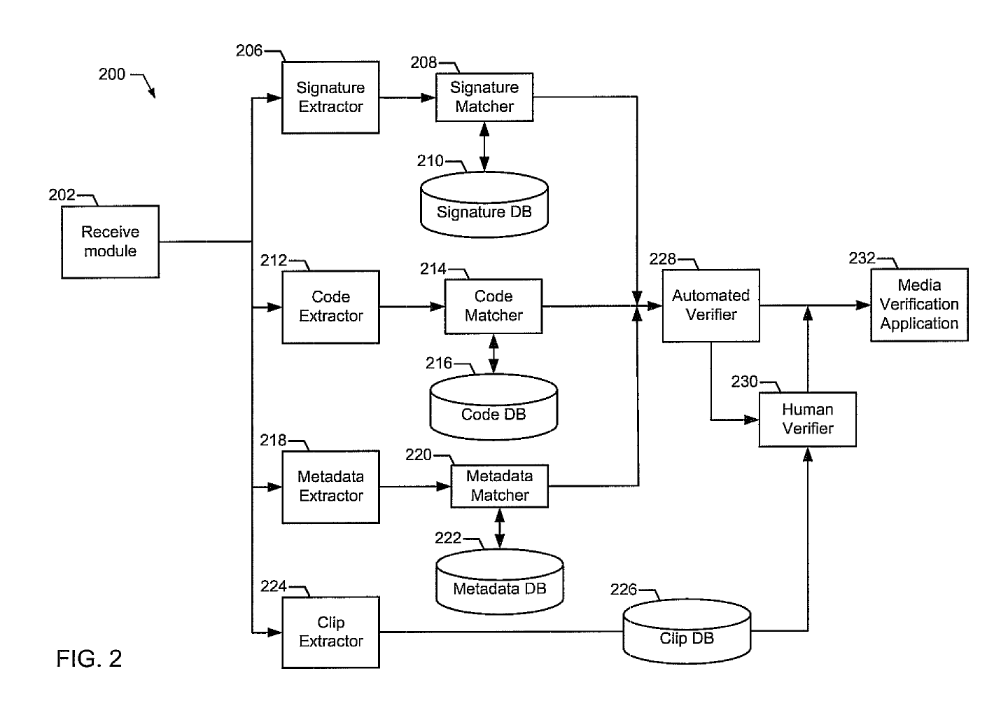

FIG. 2 is a block diagram of a media monitoring system 200 that may be used to identify encoded media content. The media monitoring system 200 may be implemented as several components of hardware, each of which may be configured to perform one or more functions, may be implemented in software or firmware where one or more programs are used to perform the different functions, or may be a combination of hardware, firmware, and/or software. In this example, the media monitoring system 200 includes a receive module 202, a signature extractor 206, a signature matcher 208, a signature database 210, a code extractor 212, a code matcher 214, a code database 216, a metadata extractor 218, a metadata matcher 220, a metadata database 222, a clip extractor 224, a clip database 226, an automated verifier 228, a human verifier 230, and a media verification application 232.

The receive module 202 is configured to receive the media content output by the transmission module 114 of FIG. 1. The receive module 202 may be configured to receive a cable transmission, a satellite broadcast, and/or an RF broadcast and process the received signal to be renderable and viewable on a television, monitor, or any other suitable media presentation device. The receive module 202 transmits the media signals (e.g., video and audio content, metadata, etc.) to the signature extractor 206, the code extractor 212, the metadata extractor 218, and the clip extractor 224.

The signature extractor 206 is configured to receive the audio and video signals and generate a signature from the audio and/or video signals. The signature extractor 206 may use any desired method to generate a signature and/or multiple signatures from the audio and/or video signals. For example, a signature may be generated using luminance values associated with video segments and/or audio characteristics of the media content. A person of ordinary skill in the art will readily appreciate that there are many methods to calculate, generate, and collect signatures.

Extracted signatures are then sent to the signature matcher 208, which compares the extracted signature to signatures stored in the signature database 210. The signature database 210 may be local to the system 200 or, alternatively, may be located at a central processing facility (not shown) and communicatively coupled to the media monitoring system 200 through a network connection and/or communicatively coupled in any other suitable manner. Signatures stored in the signature database 210 may be associated with data used to identify the media content. For example, the identifying data may include title information, length information, etc. The signature matcher 208 may use any desired method to compare the extracted signatures to signatures stored in the signature database 210. The signature matcher 208 transmits results of the comparison (e.g., the extracted signatures, the matching signatures and/or the associated identifying data) to the automated verifier 228. If the signature matcher 208 does not find a matching signature in the signature database 210, the signature matcher 208 updates the signature database 210 to include the extracted signature.

The code extractor 212 is configured to receive media signals (e.g., audio and/or video content) associated with the media content and extract ancillary codes if present. The ancillary codes may be embedded in a vertical blanking interval (VBI) of the video content and/or may be psychoacoustically masked (e.g., made inaudible to most viewers/users) when embedded in the audio content. However, a person of ordinary skill in the art will readily appreciate that there are several methods to extract ancillary codes from video and/or audio content. For example, the code extractor 212 may be configured to detect the VBI and monitor video content to determine if ancillary codes are present in the VBI. After extraction, the ancillary codes are transmitted to a code matcher 214.

The code matcher 214 is configured to receive extracted ancillary codes from the code extractor 212 and compare the extracted ancillary codes to ancillary codes stored in the code database 216. The code database 216 may be substantially similar and/or identical to the code database 106 of FIG. 1 and may be local to the system 200 or, alternatively, may be located at a central processing facility (not shown) and communicatively coupled to the media monitoring system 200 through a network connection and/or may be communicatively coupled in any other suitable manner.

The code database 216 may be configured to be updated by a user (e.g., a user downloads updated database entries) and/or may be configured to receive periodic updates from a central processing facility. The code database 216 may contain a collection of ancillary codes and the identifying data associated with the ancillary codes. The identifying data may be similar to the identifying data stored in the signature database 210 and may include title information, length information, etc. The code matcher 214 compares the extracted ancillary codes to the ancillary codes in the code database 216 and transmits the results of the comparisons (e.g., the extracted ancillary codes, the matching ancillary codes and/or the associated identifying data) to the automated verifier 228. A person of ordinary skill in the art will readily appreciate that there are several methods of comparing the extracted ancillary codes and ancillary codes in the code database 216 and, thus, these methods are not described herein. If the code matcher 214 does not find a matching ancillary code in the code database 216, the code matcher 214 updates the code database 216 to include the extracted ancillary code.

The metadata extractor 218 is configured to receive audio and/or video signals associated with the media content and to detect any metadata embedded in the audio and/or video signals. The metadata extractor 218 is configured to transmit the extracted metadata to the metadata matcher 220. The metadata extractor 218 may be implemented using program and system information protocol (PSIP) and program specific information (PSI) parsers for digital bitstreams and/or other forms of metadata in the VBI. The metadata matcher 220 is well known to a person of ordinary skill in the art and, thus, is not described further herein.

The metadata matcher 220 is configured to receive the extracted metadata and compare the extracted metadata to metadata stored in the metadata database 222. The metadata database 222 may store metadata and identifying data associated with the metadata used to identify the media content. The metadata database 222 may be local to the system 200 or may be located at a central processing facility (not shown) and may be communicatively coupled to the media monitoring system 200 through a network connection and/or may be communicatively coupled in any other suitable manner. The metadata database 222 may be updated by a user (e.g., a user may download updated database entries) and/or may receive updates from the central processing facility. The identifying data associated with the metadata may be similar to the identifying data stored in the signature database 210 and/or the code database 216. The metadata matcher 220 may compare the extracted metadata to each entry in the metadata database 222 to find a match. If the metadata matcher 220 does not find a matching entry in the metadata database 222, the metadata matcher 220 updates the metadata database 222 to include the extracted metadata and associated identifying data. The results of the comparison (e.g., the extracted metadata, the matching metadata, and/or the associated identifying data) are transmitted to the automated verifier 228.

The clip extractor 224 is configured to receive audio and/or video content associated with the detected media content and capture a segment of the audio and/or video content. The captured segment may be compressed and/or decompressed and may be captured in an analog format and/or a digital format. The clip extractor 224 may also be configured to change the resolution of the captured segment. For example, the audio and/or video content may be down-sampled so that a low resolution segment is captured. The clip extractor 224 transmits the captured segment to the clip database 226. The clip database 226 stores the captured segment and passes the captured segment to the human verifier 230.

The automated verifier 228 is configured to receive the database comparison results from the signature matcher 208, the code matcher 214, and/or the metadata matcher 220. The automated verifier 228 compares the received identifying data associated with each comparison result to attempt to determine which media content was received by the media monitoring system 200. The automated verifier 228 may determine which media content was received by comparing the identifying data (e.g., title information, author or owner information, and/or length of time information) associated with the each of the received database comparison results. If the identifying data of each of the received database comparison results are substantially similar and/or identical, the automated verifier 228 reports the received database comparison results and the identifying data associated with the received database comparison results to the human verifier 230 and the media verification application 232.

If the database comparison results are not substantially similar, the automated verifier 228 may apply a set of rules to the received comparison results so that a determination can be made. For example, the automated verifier 228 may apply rules to associate different weighting values to the different database comparison results. In one example, a large weight may be associated with the results of the signature matcher 208 so that the automated verifier 228 can determine which media content was received based primarily on the results of the signature matcher 208. The automated verifier 228 is also configured to verify that a particular portion of audio/video content has been broadcast. For example, the automated verifier 228 may be configured to determine if particular media content was broadcast in its entirety by determining if metadata corresponding to the entire media content was sequentially received. Any other methods for determining if media content was broadcast and/or presented in its entirety may be additionally or alternatively used.

The automated verifier 228 also transmits the verified results and the received database comparison results to a human verifier 230. The human verifier 230 determines if any of the received database comparison results were not found in the associated database by analyzing the received comparison results and the identifying data associated with the results. If a received database comparison result does not include any identifying data and/or a matching database entry, the human verifier 230 determines the results were not found in the associated database and updates the associated database with a new database entry including, for example, the identifying data and the extracted data. For example, the human verifier 230 may determine that the signature matcher 208 did not find a matching signature in the signature database 210 and update the signature database 210 with the identifying data associated with the media content from which the signature was generated. The human verifier 230 may use the segment captured by the clip extractor 224 to generate the identifying data and/or may use another method known to a person of ordinary skill in the art.

The media verification application 232 receives results from the human verifier 230 and the automated verifier 228. In addition, the media verification application 232 receives the captured segments from the clip database 226. The media verification application 232 may be used to generate monitoring data and/or reports from the results of the automated verifier 228 and the human verifier 230. The monitoring data and/or reports may verify media content was broadcast at the appropriate times and/or that the broadcast frequency of the media content was correct. The captured segments may be included in the monitoring data and/or reports.

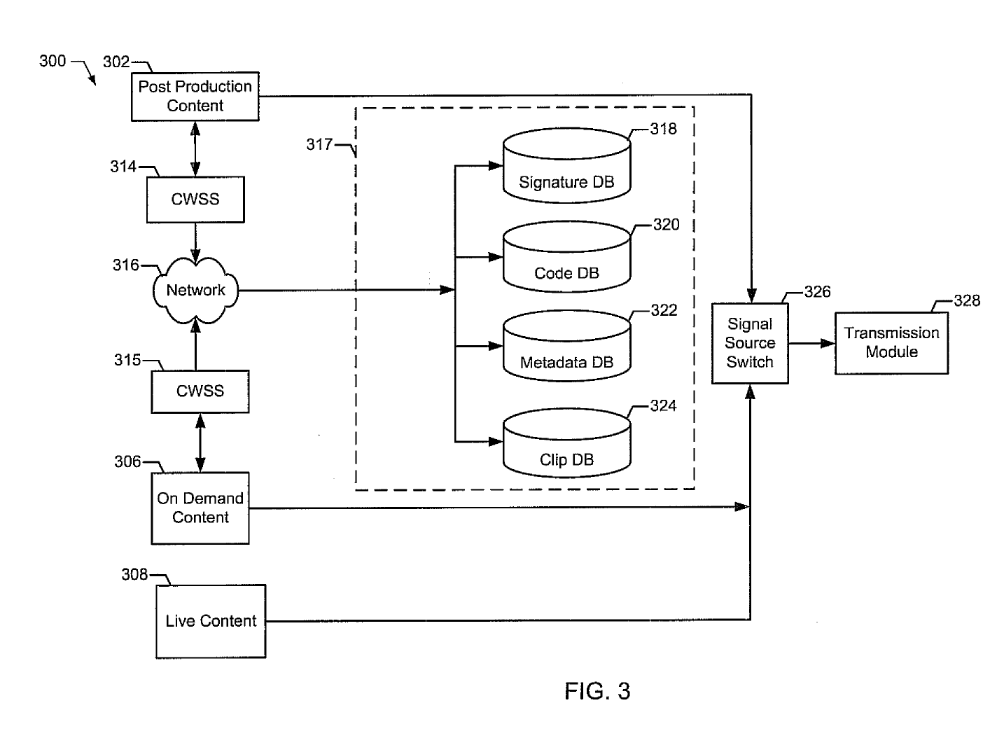

FIG. 3 is a block diagram of an example transmitter system 300 that may be used to broadcast encoded media content. The example transmitter system 300 encodes identifying data in media content and extracts or collects signatures and/or metadata from media content prior to transmission to consumers. The encoding and extracting or collecting is not performed in real-time (e.g., at the same time as the broadcast of the media content), which allows for more time in which to process the media content. In particular, the example transmitter system 300 processes (e.g., encodes, collects signatures, etc.) a plurality of media content portions (e.g., audio and/or video clips, segments, etc.) in a batch process and one or more of the plurality of media content portions are broadcast at a later time and only after all of the media content portions have been processed. As a result, the example transmitter system 300 has the advantage of allowing more identifying data to be encoded and extracted prior to broadcasting. Thus, a subsequent process for identifying media content can be provided with more identifying data to facilitate identification of received media content.

The example transmitter system 300 may be implemented as several components of hardware, each of which is configured to perform one or more functions, may be implemented in software where one or more software programs are used to perform the different functions, or may be a combination of hardware and software. In this example, the example transmitter system 300 includes post production content 302, on demand content 306, live content 308, a signal source multiplexer 326, and a transmission module 328 that are similar to the post production content 102, on demand content 108, live content 110, the signal source multiplexer 112, and the transmission module 114 of FIG. 1, respectively, and are not described again. However, the example transmitter system 300 also includes content watermarking and signature systems (CWSS's) 314 and 315, and a network 316 connecting the CWSS's 314 and 315 to a backend server/central processing facility 317.

In contrast to the known system 100 of FIG. 1, the example transmitter system 300 provides a system to encode the post production content 302 and the on demand content 306 prior to the transmission or broadcast of the content 302 and 306. The example transmitter system 300 may encode and/or associate identifying data (e.g., insert ancillary codes, insert audio watermark data, capture/generate signatures, capture/generate low resolution clips, etc.) with the post production content 302 and the on demand content 306. The identifying data is transmitted via the network 316 to the backend server/central processing facility 317. If desired, all of the post production content 302 and the on demand content 306 may be processed to enable identification of any or all of the content 302 and 306 at a later time.

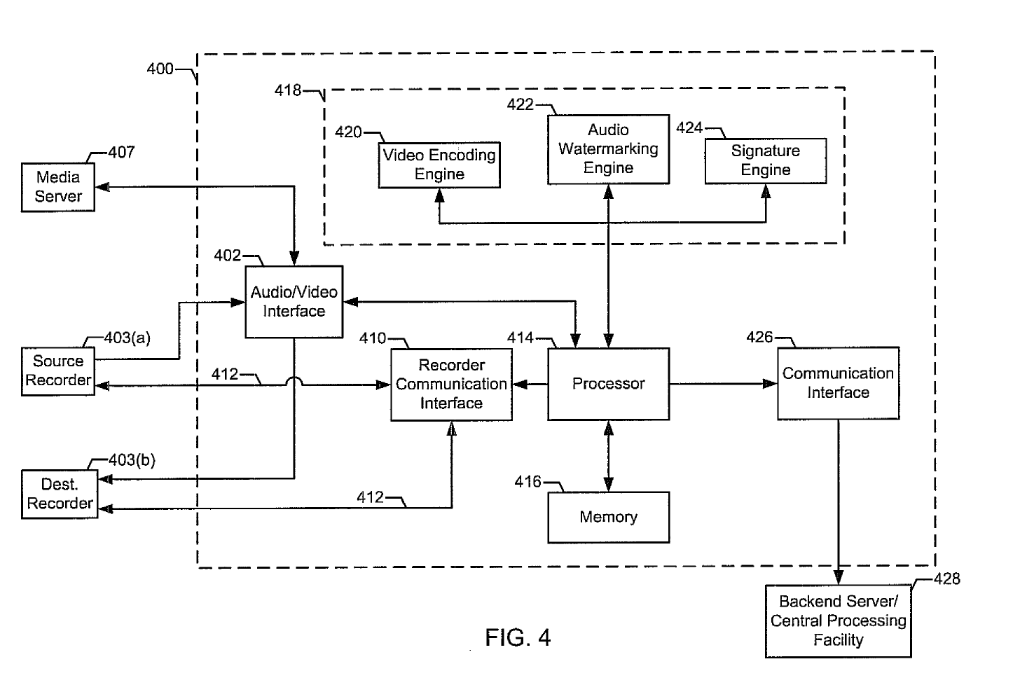

The CWSS 314 is configured to receive the post production content 302 and encode, generate, and/or associate identifying data (e.g., insert ancillary codes, insert audio watermark data, capture/generate signatures, capture/generate low resolution clips, etc.) with the post production content 302 in an offline manner. After the identifying data is captured/generated and/or associated with the post production content 302, the CWSS 314 is configured to transmit the identifying data and other associated data to the backend server/central processing facility 317. The CWSS 314 may associate the identifying data with a unique identifier (e.g., ancillary code) inserted in the media content. The backend server/central processing facility 317 may update the signature database 318, the code database 320, the metadata database 322, and/or the clip database 324 depending on the type of identifying data captured/generated for the post production content 302 as defined by a job description list (JDL) described in greater detail below. The CWSS 314 is described in further detail in conjunction with the description of FIG. 4.

The signature database 318, the code database 320, the metadata database 322, and/or the clip database 324 may be located at the same location as the example transmitter system 300 and/or may be at a remote location such as backend server/central processing facility 317 and communicatively coupled to the example transmitter system 300 via the network 316 or any other communication system. The databases 318, 320, 322, and 324 are configured to receive updates from a CWSS, such as the CWSS 314 and/or the CWSS 315, from the backend server/central processing facility 317, from a user (e.g., a user downloads updates to the databases), and/or from any other source. The databases 318, 320, 322, and 324 may be used by backend server/central processing facility 317 or a receiving site (e.g., a consumption site, a monitoring site, a reference site, etc.) to identify consumed media content by matching extracted identifying data to corresponding media content stored in the databases.

The CWSS 315 is configured to encode, capture/generate, and/or associate identifying data with the on demand content 306 in an off-line manner. Similar to the CWSS 314, the CWSS 315 is configured to transmit the identifying data and other associated data to the backend server and/or a central processing facility 317. The backend server and/or the central processing facility 317 may update the signature database 318, the code database 320, the metadata database 322, and/or the clip database 324 with the generated identifying data. The operation of CWSS 315 is described in further detail in conjunction with the description of FIG. 4.

FIG. 4 is a block diagram of an example CWSS 400 for encoding media content. The CWSS 400 may encode the media content at a location other than a broadcast location such as, for example, a media production source and/or a recording source. In addition, the CWSS 400 may encode the media content at the broadcast location if the media content is encoded off-line (e.g., not during broadcast). The CWSS 400 may encode and/or associate identifying data with the media content (e.g., insert ancillary codes, insert watermark data, capture/generate signatures, etc.) The CWSS 400 may provide the identifying data to a backend server and/or central processing facility for storage in one or more databases.

The example CWSS 400 may be implemented as several components of hardware, each of which is configured to perform one or more functions, may be implemented in software where one or more software programs are used to perform the different functions, or may be a combination of hardware and software. In this example, the example CWSS 400 includes an audio/video (A/V) interface 402; a source recorder 403(a); a destination recorder 403(b); a recorder communication interface 410; recorder communication signals 412; a processor 414; a memory device 416; an encoding engine 418 that includes a video encoding engine 420, an audio watermarking engine 422, and a signature engine 424; a communication interface 426; and a backend server/central processing facility 428. One of ordinary skill in the art will recognize that watermarking of media content is one form of encoding identifying data in the media content.

The source recorder 403(a) may store any type of media content that is to be encoded. For example, the source recorder 403(a) may store a pre-recorded infomercial, a situational comedy, a television commercial, a radio broadcast, or any other type of prerecorded media content. The media content stored on the source recorder 403(a) may consist of post production content (e.g., post production content 302), on demand content (e.g., on demand content 306), and/or any other type of prerecorded media content. The destination recorder 403(b) may be blank or may contain previously recorded media content. The destination recorder 403(b) may be capable of storing the same media content as the media content stored on source recorder 403(a) and may also be capable of storing the media content from source recorder 403(a) after it has been encoded by the CWSS system 400. The encoded media content stored on the destination recorder 403(b) may be broadcast and/or transmitted at a later time. The source recorder 403(a) and the destination recorder 403(b) may be any type of device capable of retrieving and/or recording media content from and/or to any type of medium. For example, source recorder 403(a) and destination recorder 403(b) may be a video cassette recorder (VCR), a video tape recorder (VTR), a digital video recorder (DVR), a digital versatile disc (DVD) recorder, an audio cassette recorder. A person of ordinary skill in the art will readily appreciate that the source recorder 403(a) and the destination recorder 403(b) may be exchanged or may be implemented as a single device.

The media server 407 may be any device capable of storing digital media content. For example, the media server 407 may be a personal computer (PC) having memory capable of storing digital media content. The media server 407 may be capable of transmitting media content to the CWSS system 400 and receiving and storing the media content after it has been encoded by the CWSS system 400. The media server 407 may be a part of a broadcast system for transmitting media content to media consumption sites. The media server 407 may store post production content (e.g., post production content 302), on demand content (e.g., on demand content 306), and/or any other type of prerecorded media content.

The A/V interface 402 is configured to receive analog and/or digital media inputs and to transmit analog and/or digital media outputs. In particular, the A/V interface 402 may be configured to receive analog or digital media inputs from the source recorder 403(a) and the media server 407. The A/V interface 402 may also be configured to transmit analog or digital media outputs to the destination recorder 403(b) and to the media server 407. The analog and/or digital media inputs and outputs may be received/transmitted using any method known to those of ordinary skill in the art.

The recorder communication interface 410 is configured to receive and transmit control signals to the source recorder 403(a) and the destination recorder 403(b) via the recorder communication signals 412. The recorder communication signals 412 may instruct the source recorder 403(a) and/or the destination recorder 403(b) to begin playback, seek a location, begin recording, etc. The recorder communication interface 410 may use any known communication and/or control protocol to communicate with the recorders 403(a) and 403(b). For example, a Sony 9-Pin protocol may be used to control the recorders 403(a) and 403(b).

The processor 414 may be any type of well-known processor, such as a processor from the Intel Pentium® family of microprocessors, the Intel Itanium® family of microprocessors, the Intel Centrino® family of microprocessors, and/or the Intel XScale® family of microprocessors. In addition, the processor 414 may include any type of well-known cache memory, such as static random access memory (SRAM). The memory device 416 may include dynamic random access memory (DRAM) and/or any other form of random access memory. For example, the memory device 416 may include double data rate random access memory (DDRAM). The memory device 416 may also include non-volatile memory. For example, the memory device 416 may be any type of flash memory and/or a hard drive using a magnetic storage medium, optical storage medium, and/or any other storage medium.

The processor 414 may be configured to communicate with the recorder communication interface 410 to instruct the recorder communication interface 410 to send commands to the recorders 403(a) and 403(b). For example, the processor 414 may instruct the recorder communication interface 402 to cause the source recorder 403(a) to being playback. The processor 414 is configured to receive a media signal or data from the A/V interface 402 (e.g., analog media input from the source recorder 403(a) during playback). The processor 414 may store the received media content in the memory device 416. The processor 414 may separate the received media signals or data into a video component and an audio component and store the components in separate files in the memory device 416. The processor 414 is also configured to convert media content between digital and analog formats. In addition, the processor 414 may be configured to extract low resolution clips of the video and/or audio files and store the low resolution clips in the memory device 416.

The encoding engine 418 is configured to access the video and audio files stored in the memory device 416 via the processor 414 and process the video and audio files so that video and audio content stored in the files may be identified at a later time. The encoding engine 418 is configured to encode segments of the video file and/or clips of the audio file prior to performance of broadcast operations. The CWSS 400 may be located at a facility/location other than a broadcast facility. For example, the CWSS 400 may be located at a post production site, a recording site, etc and then transmitted to the broadcast facility for transmission to consumer locations.

The video encoding engine 420 is configured to encode segments of the video file with ancillary codes using any vertical blanking interval (VBI) encoding scheme, such as the well-known Automatic Monitoring Of Line-up System, which is commonly referred to as AMOL II and which is disclosed in U.S. Pat. No. 4,025,851, the entire disclosure of which is incorporated herein by reference. However, a person of ordinary skill in the art will readily appreciate that the use of AMOL II is merely an example and that other methods may be used. The video encoding engine 420 may be configured to decompress media content files before encoding the media content or may encode the media content while it is compressed. The video encoding engine 420 may encode the video segment with ancillary codes that contain identifying data such as a title of a video segment and time stamp information. However, a person of ordinary skill in the art will readily appreciate that the video encoding engine 420 is not limited to the use of a VBI encoding algorithm and may use other encoding algorithms and/or techniques. For example, a horizontal blanking interval (HBI) encoding algorithm may be used or an over-scan area of the raster may be encoded with the ancillary codes, etc.

The audio watermarking engine 422 is configured to encode clips of the audio file using any known watermarking algorithm, such as, for example, the encoding method disclosed in U.S. Pat. No. 6,272,176, the entire disclosure of which is incorporated herein by reference. However, a person of ordinary skill in the art will readily appreciate that the example algorithm is merely an example and that other watermarking algorithms may be used. The audio watermarking engine 422 is configured to determine if the clips of the audio file are to be encoded and insert watermark data into these clips.

The signature engine 424 is configured to generate a signature from the clips of the audio file. The signature engine 424 may generate a signature for a clip of the audio file that has been encoded by the audio watermarking engine 422 and/or may generate a signature for a clip of the audio file that has not been encoded by the audio watermarking engine 422. The signature engine 424 may use any known method of generating signatures from audio clips. For example, the signature engine 424 may generate a signature based on temporal and/or spectral characteristics (e.g., maxima and minima) of the audio clip. However, a person of ordinary skill in the art will readily appreciate that there are many methods to generate a signature from an audio clip and any suitable method may be used. In addition, the signature engine 424 is configured to capture the signatures and store the signatures in the memory device 416.

The communication interface 426 is configured to transmit data associated with the video and audio files such as the data embedded or extracted by the video encoding engine 420, the audio watermarking engine 422, and/or the signature engine 424. The data associated with the video and audio files may include video code and/or ancillary code data associated with video segments, metadata associated with the watermark data, metadata associated with the signature, the low resolution video segment, and other data describing the clip such as the title information, author information, etc. The communication interface 426 may transmit the data associated with the video and audio files to the backend server/central processing facility 428 (e.g., backend server/central processing facility 317) using any known transmission protocol, such as File Transfer Protocol (FTP), e-mail, etc. The backend server/central processing facility 428 may store the received data in one or more databases for reference at a later time. The backend server/central processing facility 428 is well known to a person of ordinary skill in the art and is not further described herein.

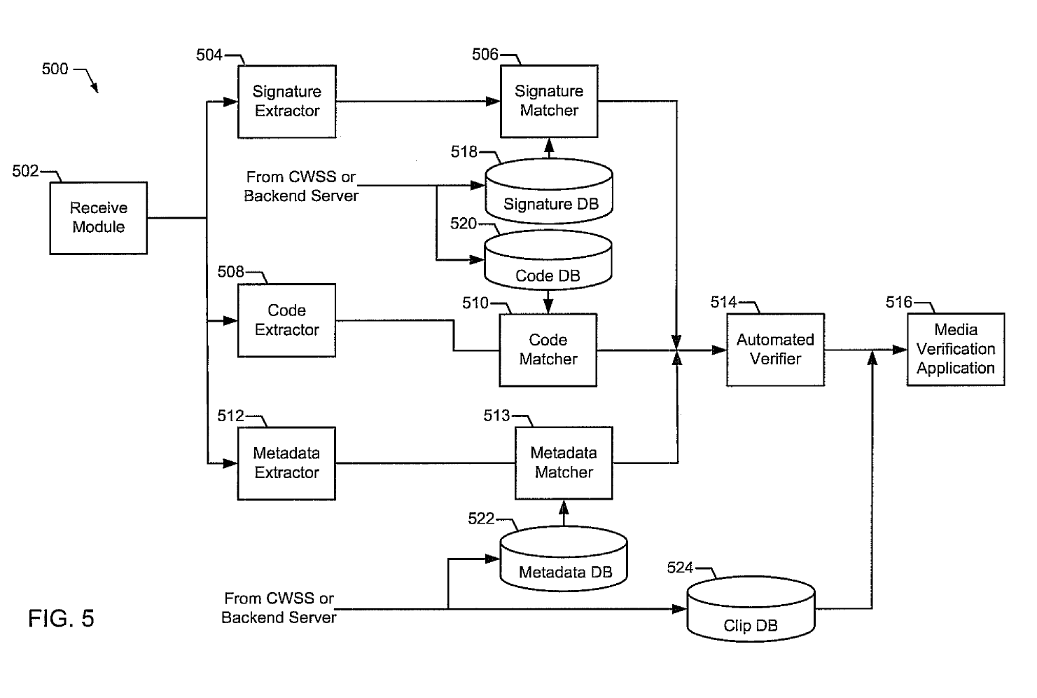

FIG. 5 is a block diagram of an example monitoring system 500 that may be used to identify encoded media content in conjunction with the example transmitter system 300 of FIG. 3. The monitoring system 500 may be implemented as a media system having several components of hardware, each of which is configured to perform one or more functions, may be implemented in software where one or more software programs are used to perform the different functions, or may be a combination of hardware and software. In this example, the monitoring system 500 includes a receive module 502, a signature extractor 504, a signature matcher 506, a code extractor 508, a code matcher 510, a metadata extractor 512, a metadata matcher 513, an automated verifier 514, and a media verification application 516 that are similar to the receive module 202, the signature extractor 206, the signature matcher 208, the code extractor 212, the code matcher 214, the metadata extractor 218, the metadata matcher 220, the automated verifier 228, and the media verification application 232 of FIG. 2 and, thus, are not described again herein. In addition, the monitoring system 500 includes and/or has access to a signature database 518, a code database 520, a metadata database 522, and a clip database 524, which may be similar to the signature database 210, the code database 216, the metadata database 222, and the clip database 226 of FIG. 2. Further, the signature database 518, the code database 520, the metadata database 522, and the clip database 524 are substantially similar to the signature database 318, the code database 320, the metadata database 322, and the clip database 324 of FIG. 3.

In contrast to the media monitoring system 200 of FIG. 2, the databases 518, 520, 522, and 524 can communicate with a CWSS system such as the CWSS 314 and/or the CWSS 315 and/or a backend server/central processing facility such as the backend server 317 of FIG. 3. The databases 518, 520, 522, and 524 may be queried to determine if a match is found within the database and may be communicatively coupled to the media monitoring system through a network connection similar to the databases of FIG. 2. For example, the signature matcher 506 may query the signature database 518 to attempt to find a match for a signature extracted by the signature extractor 504.

In contrast to the example monitoring system 200 of FIG. 2, the example monitoring system 500 of FIG. 5 does not include the human verifier 230. The human verifier 230 is not required in the example system 500 because, in contrast to the system of FIG. 2, identifying data associated with all of the received media content is contained in at least one of the databases 518, 520, 513, and 522 and, thus, will always be identifiable by the system 500.

Although FIGS. 3 and 5 illustrate a media verification system implemented using the CWSS 400 of FIG. 4, a person of ordinary skill in the art will readily appreciate that the CWSS 400 may be used to implement other media tracking, monitoring, and/or identification systems. For example, the CWSS 400 may be used to implement a television rating system.

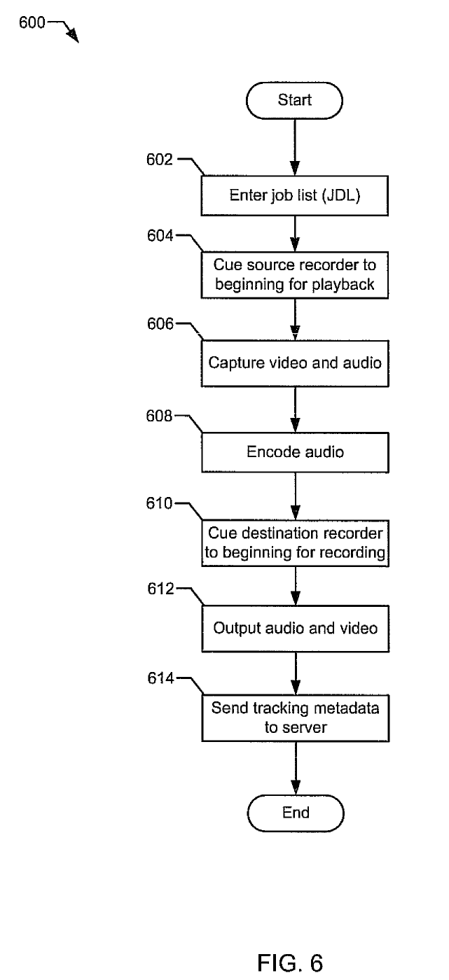

FIG. 6 is a flowchart representative of an example manner in which the apparatus of FIG. 4 may be configured to encode media signals prior to performance of broadcast operations (e.g., at the production source, source tape or file, etc. of the media signals). The example media encoding process 600 may be implemented using one or more software programs that are stored in one or more memories such as flash memory, read only memory (ROM), a hard disk, or any other suitable storage device and executed by one or more processors, which may be implemented using microprocessors, microcontrollers, digital signal processors (DSPs) or any other suitable processing device(s). However, some or all of the blocks of the example media encoding process 600 may be performed manually and/or by some other device. Although the example media encoding process 600 is described with reference to the flowchart illustrated in FIG. 6, a person of ordinary skill in the art will readily appreciate that many other methods of performing the example media encoding process 600 may be used. For example, the order of many of the blocks may be altered, the operation of one or more blocks may be changed, blocks may be combined, and/or blocks may be eliminated.

The example media encoding process 600 begins when a job decision list (JDL) is entered by a user and/or is opened from the memory device 416 of FIG. 4 (block 602). The JDL may include data and/or metadata describing video segments and/or audio clips and tasks to be performed by the encoding engine 418 in connection with each of the video segments and/or audio clips. For example, the JDL may contain data and/or metadata describing the video segment (e.g., title, length of time, author or owner, etc.) and the output format (e.g., digital or analog, compressed or decompressed). In addition, the JDL may contain data and/or metadata indicating the types of identifying data (watermark data, signature data, and/or ancillary codes) to be generated/captured and/or associated with each of the audio clips and video segments. For example, metadata may instruct the encoding engine 418 to encode watermark data and generate a signature for a first audio clip and generate a signature for the second audio clip without encoding the second clip with watermark data. In this manner, the JDL allows the user to individually define the encoding tasks for each audio clip and video segment.

After the JDL has been entered by a user or opened from the memory device 416, the processor 414 controls the source recorder 403(a) via the recorder communication interface 410 to prepare the source recorder 403(a) for playback (e.g., advance and/or rewind the source tape to the appropriate starting position) (block 604). Alternatively, the processor 414 may control the media server 407 to prepare for transmission of the digital media stored in the media server 407. For clarity, the following discussion will describe the media content as being from the source recorder 403(a). However, it should be understood that the media content may alternatively be provided by the media server 407 and/or any other suitable device(s).

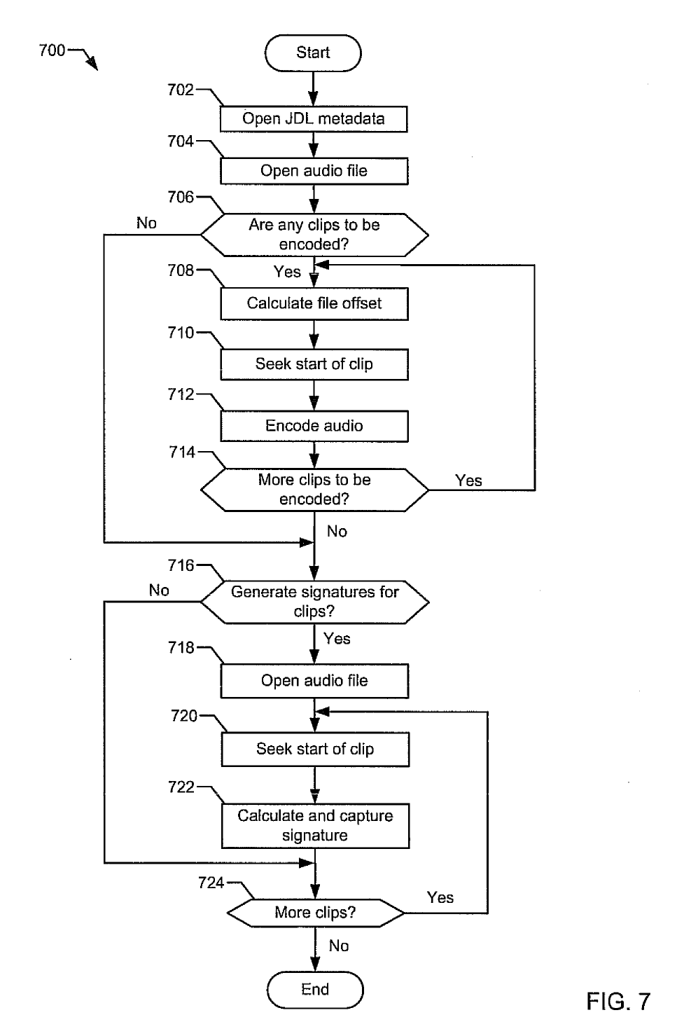

The processor 414 may use information contained in the JDL to determine the appropriate starting position for playback of the source recorder 403(a) to begin. As the source recorder 403(a) begins playback, the media content (e.g., video and/or audio content) is received by the A/V interface 402 and is captured by the processor 414 (block 606). The media content is stored in the memory device 416 in separate files (e.g., a video file and an audio file) and may be stored using a compressed digital format and/or a decompressed digital format. The processor 414 may also down-sample a portion of the media content to create a low resolution clip, which may be stored in the memory device 416. After playback ends and the media content has been captured and stored in the memory device 416, the processor 414 encodes the audio file (block 608). The encode audio process of block 608 is described in further detail in FIG. 7.

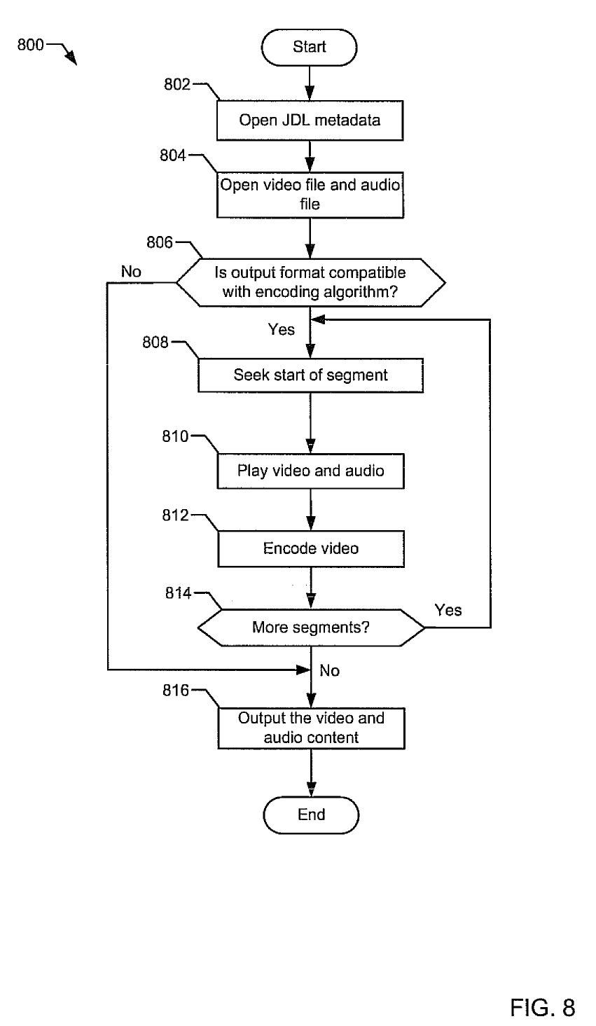

After the audio file content has been encoded (block 608), the processor 414 prepares the destination recorder 403(b) to record the encoded data (block 610). The destination recorder 403(b) may be prepared to record encoded media content by advancing the position of a destination tape to the appropriate location (e.g., start of the tape) to begin recording. The processor 414 then outputs the encoded audio and video content for the destination recorder 403(b) to record (block 612). The processor 414 may additionally or alternatively output the media content to the source recorder 403(a) and/or the video server 407. The output audio and video process of block 612 is described in further detail in FIG. 8.

The communication interface 426 collects metadata generated during the encoding of the video segments, the encoding of the audio segments and the collection of the signature(s). Metadata may include information contained in the JDL such as title, creation date, asset id, and/or information created by the video engine 420, the audio watermarking engine 422, the signature engine 424 and/or the memory device 416. In addition to the collected metadata, the communication interface 426 may also collect the low resolution portion or clips of the media content. The collected metadata and the low resolution clips are then transmitted to the backend server/the central processing facility 428 (block 614). The backend server/central processing facility 428 may use the collected metadata to populate and/or update databases such as the signature database 518 of FIG. 5.

FIG. 7 is a flowchart representative of an example manner in which the audio encoding process of block 608 (FIG. 6) may be implemented. The example audio encoding process 700 begins when the audio watermarking engine 422 opens the JDL metadata and analyzes the JDL metadata to determine the tasks to be performed on audio clips contained in the audio file (block 702). The audio file may contain several audio clips. For example, if the audio file includes audio content for a half hour television program, the audio file may contain audio clips associated with the television program and audio clips associated with commercials that are presented during the half hour television program. Alternatively, the audio file may contain several different commercials and no other program content. In any case, each of the audio clips may require different identifying data to be generated as specified by the JDL. For example, an audio clip associated with a television program may require (as specified by the JDL) both a signature and watermark data to be generated, while an audio clip associated with the commercial may require (as specified by the JDL) only a signature to be generated. The audio watermarking engine 422 then opens the audio file (block 704).

The audio watermarking engine 422 analyzes the JDL metadata to determine if an audio clip in the audio file is to be encoded (block 706). If no audio clip in the audio file is to be encoded, control advances to block 716. If at least one audio clip is to be encoded, the audio watermarking engine 422 calculates an offset from the beginning of the audio file (block 708) and then seeks the beginning of the audio clip in the audio file (block 710). The offset may be calculated/generated using information contained in the JDL metadata using, for example, a start time of the audio clip with respect to the beginning of the audio file and the number of bytes used to represent a second and/or a fraction of a second of the audio content in the audio file.

After the audio watermarking engine 422 finds the starting position of the audio clip to be encoded, the audio watermarking engine 422 generates the watermark data and inserts and/or encodes the watermark data into the audio clip (block 712). The audio watermarking engine 422 may use any known watermarking method to generate and insert the watermark data. One example watermarking algorithm is disclosed in U.S. Pat. No. 6,272,176. The encoded audio clip may be written to a new audio file (e.g., an encoded audio file).

After the audio clip has been encoded (block 712), the audio watermarking engine 422 analyzes the JDL metadata to determine if other audio clips in the audio file are to be encoded (block 714). If other audio clips are to be encoded (block 714), control returns to block 708. Otherwise, control advances to block 716 and the signature engine 424 determines if signatures are to be calculated/generated for an audio clip within the audio file and/or encoded audio file (block 716). If no signature is to be calculated/generated for an audio clip within the audio file and/or the encoded audio file, control returns to block 610 of FIG. 6.

If the JDL metadata indicates that at least one signature is to be calculated/generated for an audio clip within the audio file (block 716), the signature engine 424 opens the appropriate audio file (block 718), seeks the beginning of the audio clip (block 720), generates the signature for the audio clip and stores the signature in the memory device 616 (block 722). The signature engine 424 determines from the JDL metadata if any other audio clips require signatures (block 724). If additional audio clips require signatures, control advances to block 720. Otherwise, control returns to block 610 of FIG. 6.

FIG. 8 is a flowchart representative of an example manner in which the audio and video output process of block 612 (FIG. 6) may be implemented. The example audio and video output process 800 begins when the video encoding engine 420 opens the JDL metadata (block 802). The video encoding engine 420 may analyze the JDL metadata to determine the output format of the video and audio content. For example, the output format of the video and audio files may be a compressed digital format, a decompressed analog format, and/or a decompressed digital format.

The video encoding engine 420 then opens the video and audio files (block 804) and determines if the output format is compatible with a video encoding algorithm (block 806). For example, if the video encoding engine 420 uses a VBI encoding algorithm and the output format is a compressed digital format, then the VBI encoding algorithm is not compatible. A person of ordinary skill in the art will readily appreciate that the VBI encoding algorithm is an example and that other encoding algorithms may be used by the video encoding engine 420.

If the output format is not compatible with the video encoding algorithm, control advances to block 816 because the video segment will be output without being encoded. If the output format is compatible with the video encoding algorithm, the video encoding engine 420 analyzes the JDL metadata, seeks the start of the video segment to be encoded, and synchronizes the associated audio clip to the proper starting position (block 808).

After the video encoding engine 420 finds the start of the segment to be encoded, the video encoding engine 420 begins playback of the video segment and the associated audio clip (block 810). The term playback, as used herein, is intended to refer to any processing of a media content signal or stream in a linear manner whether or not emitted by a presentation device. As will be understood by one having ordinary skill in the art, playback may not be required when performing some encoding and/or signature extraction/collection techniques that may encode and/or extract/collect signature identifying data in a non-linear manner. This application is not limited to encoding and/or signature extraction/collection techniques that use linear or non-linear methods, but may be used in conjunction with any suitable encoding and/or signature extraction/collection techniques. If the video segment is stored in a compressed digital format, the video segment is decompressed before playback begins. As playback of the video and audio content occurs, the video content is encoded with ancillary codes that contain identifying data (block 812). The VBI of the video segment may be encoded with data such as the author of the video segment, the title of the video segment, the length of segment, etc. Persons of ordinary skill in the art will readily appreciate that there are several ways to encode a video segment such as, for example, the AMOL II encoding algorithm and the HBI encoding algorithm.

After the video segment is encoded, the video encoding engine 420 analyzes the metadata to determine if other video segments are to be encoded (block 814). If other video segments are to be encoded, control returns to block 808. Otherwise, the A/V interface 402 outputs the video and audio content in the output format (e.g., an analog output format, a compressed digital format, and/or a decompressed digital format) as specified in the JDL metadata (block 816). The A/V interface 402 may output the encoded video and/or audio content to the source recorder 403(a), the destination recorder 403(b), and/or the media server 407 for future transmission or broadcast. Control then returns to block 614 of FIG. 6.

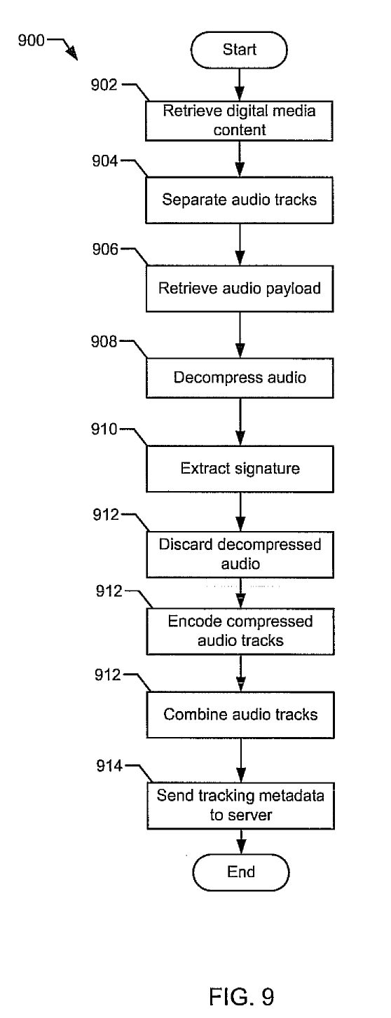

FIG. 9 is a flowchart representative of an example manner in which compressed digital media content may be encoded by the CWSS 314 and/or the CWSS 315. The example encoding process 900 begins when the digital media content is retrieved from its source (block 902). The digital media content may be stored at the source recorder 403(a), the destination recorder 403(b), the video server 407, or any other location suitable for storing digital media content. If the compressed digital media content is stored on the video server 407, the media content will be contained in one or more media content files. For example, the compressed media content may be stored in an MPEG 4 encoded media file that contains video and multiple audio tracks. Therefore, the number of audio tracks is determined and the audio tracks are individually extracted from the media file (block 904). The audio tracks may include metadata such as headers and indices and, thus, the payload portion (e.g., the actual compressed audio) is extracted from the media content file (block 906).

The CWSS 314 and/or the CWSS 315 may then decompress the audio payload to obtain the decompressed audio data so that a signature may be extracted or collected (block 910). The decompressed version of the audio payload may then be discarded (block 912). One of ordinary skill in the art will recognize that there are many methods for extracting or collecting signatures of decompressed digital audio and that any suitable signature extraction of collection method may be utilized.

The CWSS 314 and/or the CWSS 315 may then add identifying data to the compressed digital audio tracks (block 914). Any method for encoding compressed digital audio may be used such as, for example, the encoding method disclosed in U.S. Pat. No. 6,272,176. Encoding the compressed version of the audio tracks eliminates the loss of quality issues that may occur when audio tracks are decompressed, encoded, and then re-compressed.

After all desired audio tracks have been encoded, the audio tracks are combined with the other content of the compressed digital media file (block 916). The media content may be stored in the same format as the input media content file or may be stored in any other format that is desired. After the media content file is reassembled, the digital media content is then stored at the output device (block 918). The output device may be the video server 407, the source recorder 403(a), the destination recorder 403(b), or any other suitable output device. Any identifying data retrieved or encoded in the media content file may be sent to the backend server/central processing facility, such as, for example, backend server/central processing facility 317.

One of ordinary skill in the art will recognize that the process 900 is merely an example and that there are many other ways to implement the same process. For example, some blocks may be added, some blocks may be removed, and/or the order of some blocks may be changed.

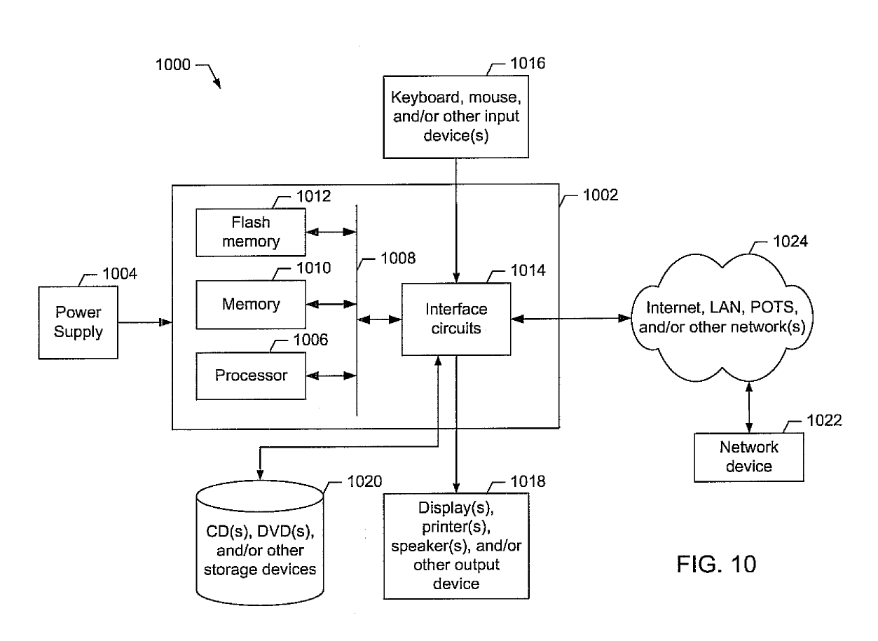

FIG. 10 is a block diagram of an example computer system that may be used to implement the example apparatus and methods disclosed herein. The computer system 1000 may be a personal computer (PC) or any other computing device. In the illustrated example, the computer system 1000 includes a main processing unit 1002 powered by a power supply 1004. The main processing unit 1002 may include a processor 1006 electrically coupled by a system interconnect 1008 to a main memory device 1010, a flash memory device 1012, and one or more interface circuits 1014. In the illustrated example, the system interconnect 1008 is an address/data bus. Of course, a person of ordinary skill in the art will readily appreciate that interconnects other than busses may be used to connect the processor 1006 to the other devices 1010-914. For example, one or more dedicated lines and/or a crossbar may be used to connect the processor 1006 to the other devices 1010-914.

The processor 1006 may be any type of well known processor, such as a processor from the Intel Pentium® family of microprocessors, the Intel Itanium® family of microprocessors, the Intel Centrino® family of microprocessors, and/or the Intel XScale® family of microprocessors. The processor 1006 and the memory device 1010 may be significantly similar and/or identical to the processor 414 (FIG. 4) and the memory device 416 (FIG. 4) and the descriptions will not be repeated herein.

The interface circuit(s) 1014 may be implemented using any type of well known interface standard, such as an Ethernet interface and/or a Universal Serial Bus (USB) interface. One or more input devices 1016 may be connected to the interface circuits 1014 for entering data and commands into the main processing unit 1002. For example, an input device 1016 may be a keyboard, mouse, touch screen, track pad, track ball, isopoint, a recorder, a digital media server, and/or a voice recognition system.

One or more displays, printers, speakers, and/or other output devices 1018 may also be connected to the main processing unit 1002 via one or more of the interface circuits 1014. The display 1018 may be a cathode ray tube (CRT), a liquid crystal displays (LCD), or any other type of display. The display 1018 may generate visual indications of data generated during operation of the main processing unit 1002. The visual indications may include prompts for human operator input, calculated values, detected data, etc.

The computer system 1000 may also include one or more storage devices 1020. For example, the computer system 1000 may include one or more compact disk drives (CD), digital versatile disk drives (DVD), and/or other computer media input/output (I/O) devices.

The computer system 1000 may also exchange data with other devices 1022 via a connection to a network 1024. The network connection may be any type of network connection, such as an Ethernet connection, digital subscriber line (DSL), telephone line, coaxial cable, etc. The network 1024 may be any type of network, such as the Internet, a telephone network, a cable network, and/or a wireless network. The network devices 1022 may be any type of network devices 1022. For example, the network device 1022 may be a client, a server, a hard drive, etc.

Although the following discloses example systems, including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the following describes example systems, persons of ordinary skill in the art will readily appreciate that the examples are not the only way to implement such systems.

Although certain methods, apparatus, and articles of manufacture have been described herein, the scope of coverage of this patent is not limited thereto. On the contrary, this patent covers all apparatus, methods and articles of manufacture fairly falling within the scope of the appended claims either literally or under the doctrine of equivalents.

What is claimed is:

1. A method of preparing media content for identification, the method comprising:
receiving compressed media content;
decompressing the payload of the compressed media content;
generating a signature of the decompressed payload;
discarding the decompressed payload;
embedding a code in the compressed media content; and
storing the code and the signature in a database for later use in identifying presentation of the media content at a presentation site.

2. A method as defined in claim 1, further comprising collecting metadata from the decompressed payload and storing the metadata in a database.

3. A method as defined in claim 2, further comprising collecting a clip from the decompressed payload and storing the clip in a database.

4. A method as defined in claim 3, further comprising:
receiving the media content at the presentation site;
attempting to collect a signature from the received media content;
attempting to collect a code from the received media content;
attempting to collect at least one of metadata and a clip from the received media content;
if a signature is collected, comparing the collected signature to signatures in the database;
if a code is collected, comparing the collected code to codes in the database;
if at least one of metadata or a clip is collected, comparing the collected metadata or the collected clip to metadata or clips in the database;
weighting the results of the comparisons; and
combining the weighted results to identify the received media content.

5. A method as defined in claim 1, further comprising transmitting the media content to a presentation site.

6. A method as defined in claim 1, wherein the media content is video on demand media content.

7. A method as defined in claim 1, wherein embedding the code in the compressed media content comprises adding a code to an audio portion of the compressed media content.

8. A system for preparing media content for identification, the system comprising:
an interface to receive compressed media content;
a processor to decompress the payload of the compressed media content;
a signature engine to generate a signature of the decompressed payload and to discard the decompressed payload;
a code injector to inject a code in the compressed media content; and
a memory to store the code and the signature for later use in identifying presentation of the media content at a presentation site.

9. A system as defined in claim 8, further comprising a metadata extractor to collect metadata from the decompressed payload and storing the metadata in the memory.

10. A system as defined in claim 9, further comprising a clip extractor to collect a clip from the decompressed payload and store the clip in the memory.

11. A system as defined in claim 10, further comprising:
a receiver to receive the media content at the presentation site;
a signature extractor to attempt to collect a signature from the received media content;
a code extractor to attempt to collect a code from the received media content;
a metadata extractor to attempt to collect at least one of metadata and a clip from the received media content; and
a media verification application to compare the collected signature to signatures in the memory if a signature is collected, to compare the collected code to codes in the memory if a code is collected, to compare the collected metadata or the collected clip to metadata or clips in the memory if at least one of metadata or a clip is collected, to weight the results of the comparisons, and to combine the weighted results to identify the received media content.

12. A system as defined in claim 8, further comprising a transmission module to transmit the media content to a presentation site.

13. A system as defined in claim 8, wherein the media content is video on demand media content.

14. A system as defined in claim 8, wherein the code injector is a video encoding engine and injecting a code in the compressed media content comprises injecting the code in an audio portion of the compressed media content.

15. A machine readable medium storing machine readable instructions, which, when executed, cause a machine to:
receive compressed media content;
decompress the payload of the compressed media content;
generate a signature of the decompressed payload and to discard the decompressed payload;
inject a code in the compressed media content; and
store the code and the signature in a database for later use in identifying presentation of the media content at a presentation site.

16. A machine readable medium as defined in claim 15, wherein the machine readable instructions further cause the machine to collect metadata from the decompressed payload and storing the metadata in a database.

17. A machine readable medium as defined in claim 16, wherein the machine readable instructions further cause the machine to collect a clip from the decompressed payload and store the clip in a database.

18. A machine readable medium as defined in claim 17, wherein the machine readable instructions further cause the machine to:
receive the media content at the presentation site;
attempt to collect a signature from the received media content;
attempt to collect a code from the received media content;
attempt to collect at least one of metadata and a clip from the received media content;
compare the collected signature to signatures in the database if a signature is collected;
compare the collected code to codes in the database if a code is collected;
compare the collected metadata or the collected clip to metadata or clips in the database if at least one of metadata or a clip is collected;
weight the results of the comparisons; and
combine the weighted results to identify the received media content.

19. A machine readable medium as defined in claim 15, wherein the machine readable instructions further cause the machine to transmit the media content to a presentation site.

20. A machine readable medium as defined in claim 15, wherein the media content is video on demand media content.

21. A machine readable medium as defined in claim 15, wherein the machine readable instructions further cause the machine to inject the code in an audio portion of the compressed media content.
